(19) United States
(12) Patent Application Publication
(10) Pub. No.: US 2005/0016907 A1
(43) Pub. Date: Jan. 27, 2005

(54) Electro-optical water sterilizer

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 10/890,966

(22) Filed: Jul. 13, 2004

(30) Foreign Application Priority Data
Jul. 22, 2003 (CN) 03146094.1
Jul. 22, 2003 (CN) 03277177.0

(51) Int. Cl. B01D 17/12

(52) U.S. Cl. 210/143; 210/192; 210/243; 422/186.3; 250/435

(57) ABSTRACT

The present invention relates to a water purifier and more particularly, it relates to an electro-optical water purifier which employs ultraviolet light with the wavelength of 253.7 nanometers and provides a spiral circulation for influent water to achieve disinfection of drinking water wherein said circuitry having an ability to adapt power source of alternate current (AC). A quartz bushing prevents fault electricity discharge from said UV tube, which is interchargablely connected with power source, therefore assure user's safety and ensure UV's complete emission.

### BACKGROUND OF THE PRESENT INVENTION

The present invention relates to a water purifier and more particularly, it relates to an electro-optical water purifier which employs ultraviolet light with the wavelength of 253.7 nanometers and provides a spiral circulation for influent water to achieve disinfection of drinking water

### FIELD OF THE INVENTION

It is well known in the art to use ultraviolet light (UV) for the disinfection treatment of water. Ultraviolet light, at the germicidal wavelength of 253.7 nanometers, alters the genetic (DNA) material in cells so that bacteria, viruses, molds, algae and other microorganisms can no longer reproduce. The microorganisms are considered dead, and the risk of disease from them is eliminated. As the water flows past the UV lamps in UV disinfection systems, the microorganisms are exposed to a lethal dose of UV energy. UV dose is measured as the product of UV light intensity times the exposure time within the UV lamp array. Microbiologists have determined the effective dose of UV energy to be approximately about 34,000 microwatt-seconds/cm2 needed to destroy pathogens as well as indicator organisms found in wastewater. Typical prior art disinfection systems and devices emit UV light at approximately 254 nm, which penetrates the outer cell membrane of microorganisms, passes through the cell body, reaches the DNA and alters the genetic material of the microorganism, destroying it without chemicals by rendering it unable to reproduce. Ultraviolet light is classified into three wavelength ranges: UV-C, from 200 nanometers (run) to 280 nm; UV-B, from 280 nm to 315 nm; and UV-A, from 315 nm to 400 nm. Generally, UV light, and in particular, UV-C light is “germicidal,” i.e., it deactivates the DNA of bacteria, viruses and other pathogens and thus destroys their ability to multiply and cause disease, effectively resulting in sterilization of the microorganisms. Specifically, UV “C” light causes damage to the nucleic acid of microorganisms by forming covalent bonds between certain adjacent bases in the DNA. The formation of these bonds prevents the DNA from being “unzipped” for replication, and the organism is unable to reproduce. In fact, when the organism tries to replicate, it dies. UV light with a wavelength of approximately between about 250 to about 260 nm provides the highest germicidal effectiveness. While susceptibility to UV light varies, exposure to UV energy for about 20 milliwatt-seconds/cm.sup.2 is adequate to deactivate 99 percent of the pathogens. Exposure to pathogens does not always cause disease, whether drinking contaminated water could produce disease depends on ingested and the health (nutritional and immunological) status of the person drinking the water. After studying certain variables, including the species and number of pathogens, the World Health Organization (WHO) has determined a standard of performance that must be met by acceptable water disinfection systems. The standard requires that an acceptable water disinfection system must be able to process contaminated water with 100,000 CFUs (colony forming units) of e-coli per 100 ml of water and produce outlet water with less than one CFU per 100 ml.

Generally, UV disinfection is a safe and reliable means for disinfecting drinking water for daily use, particularly given its relatively rapid, inexpensive, non-taste and odorless resultant treated water. UV light is a World Health Organization-approved method of disinfecting drinking water (Guidelines for Drinking Water Quality, vol. 1, World Health Organization, Geneva, Switzerland, 1993, p. 135). However, UV disinfection is not generally recommended for long-term storage of water.

Ultraviolet light has a proven track record of killing bacteria and viruses found in municipal wastewater. In addition, environmental concerns over the use of chemical disinfectants, coupled with improvements in ultraviolet-lighting technology, have led to the development of UV systems that treat spent metalworking fluids in the industrialized world; disinfect drinking water in developing countries; and clean aquaculture water, ballast water, and hospital air everywhere. Typically, chlorine gas or liquid is injected by a high-speed inductor directly into wastewater to kill bacteria before the water is discharged. According to industry experts, the main advantage of using UV instead of standard disinfection techniques is elimination of the transport and use of chlorine possible with the UV light-based system.

Used properly, ultraviolet light effectively destroys bacteria, viruses and other microorganisms in water and wastewater, without using chemicals. By doing away with chemical treatment, many other problems are also eliminated. There is no longer any need to worry about operator safety or the requirement for buildings for storage and handling of dangerous solutions and gases. Costly liability insurance premiums are significantly reduced. Testing of effluent for chlorine residual is no longer necessary, and toxicity problems associated with chlorine use are eliminated. Another factor leading municipalities to reconsider chlorination is its increased cost due to the national Uniform Fire Code adopted in 1993, which specifies expensive requirements for double containment of stored chlorine and chemical scrubbers in case of leaks.

Prior art applications of UV light used for disinfection of water include private drinking water supplies, municipal drinking water treatment plants, industrial product and process waters, and commercial applications, and wastewater treatment in primary, secondary, and tertiary treatment process for industrial, commercial and municipal wastewater treatment applications.

While UV purification is well suited for many residential, commercial, industrial and municipal water and wastewater treatment applications, considerations of the water quality and about the desired or required effluent purity impact the system design and performance. Prior art UV disinfectant systems work best when the water temperature is between about 35 and about 110 degrees Fahrenheit, since extreme cold or heat will interfere with the UV system performance.

Numerous patents have been granted regarding to water purifiers which employs UV to disinfect drinking water. U.S. Pat. No. 6,652,816 discloses a mean of water purifier using UV by without any anti-leakage ability.

U.S. Pat. No. 6,583,422 provides a water purifier only emphasis how easy to assembly and configure to its preferred embodiment without consider the level of the purification of drinking water since the inter-reactions between influent water and ultraviolet light tube are so prompt. It does not provide enough time for the UV perishes bacteria and other undated items contain in such influent water.

U.S. Pat. No. 6,607,668 provides a mean of water purification method which employs both ultraviolet lights and membrane aiming its reverse osmosis achievement. However, it is so complicated in assembly and so difficult to apply to household use.

U.S. Pat. No. 6,447,721 provides a means of water purifier which is having at least one mean of UV light is not being submerged in the fluid to be disinfected in order to maintain a cost-effectiveness on replacing such UV lights and the overall maintenance costs for such water purifier. However, such costly replacement and maintenance costs reflect the limitation of such invention. Problem of having at least one mean of UV light being exposed into the air or outside of such water purifier which may lead more polluted drinking water to disinfected water.

### DESCRIPTION OF RELATED ARTS

### SUMMARY OF THE PRESENT INVENTION

A main object of present invention is to provide a water purifier which uses ultraviolet light with the wavelength of 253.7 nanometers and provides higher purification level of purifying water by having influent water engage more contacts with UV lights by providing a spiral circulation for influent water.

Another object of present invention is to provide a water purifier having anti-leakage ability.

Another object of present invention is to provide a water purifier having an ability to purify drinking by UV lights without a membrane as it is under reverse osmosis with a piece of membrane.

Another object of present invention is to provide a water purifier having an ability to provide low maintenance costs and user-friendly assembly without complicated installation process.

Another object of present invention is to provide a water purifier having an ability to adapt power source of alternate current (AC).

Accordingly, in order to accomplish to the above, a water purifier comprising:
a metallic three dimensional housing,
a plurality of quartz bushing,
a plurality of ultraviolet emission tube,
a plurality of spiral pipeline,
at least one water proof cover,
a plurality emission supporting base with ventilation holes,
a plurality of electricity input line,
at least one electricity generator,
a plurality of electricity rectification transformer and
at least one switch.

The present invention uses quarts s bushing as a sleeve for UV emission tube. It utilizes emitted UV to kill bacteria in water passing through the quarts glass bushing. It comprises of outer metal shell, quartz bushing, UV emission tube and water proof cover. When water comes in from the inlet of the water purifier, the spiral pipeline allows water to run through the centered quartz bushing in a circular motion. Said UV tube inside of said bushing emits UV to kill bacteria of said influent water that flow through said quartz bushing. Disinfected water then comes out from said water purifier outlet. Said water purifier is equipped with at least one water inlet and at least one water outlet. UV tube is fixed inside of said quartz bushing, and said quartz bushing is located at center portion of said water purifier. As contaminated water come into said water purifier through said water inlet, said spiral pipeline slows down its water current, making it fully encircles said quartz bushing, wherein, an UV emitted from the UV tube ceases bacteria in the water. The purified water then is released from said outlet; achieve purpose of improving water quality.

### BRIEF DESCRIPTION OF THE DRAWINGS

FIG. 1 is a front view of the present invention.

FIG. 2 is a sectional view thereof.

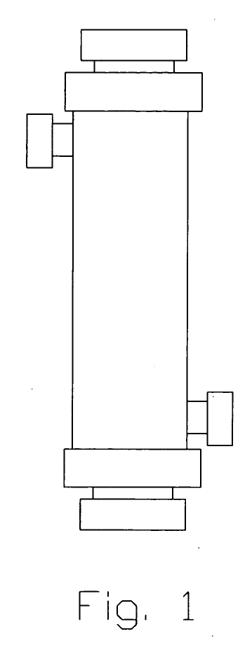

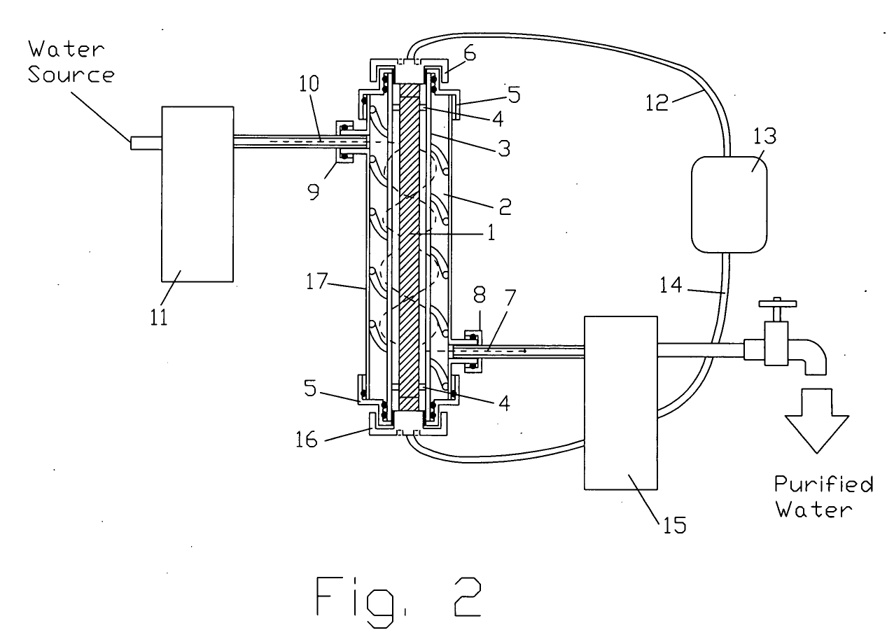

Illustration 3 is a side view thereof.

Illustration 4 is a supine and base view thereof.

### DETAILED DESCRIPTION OF THE PREFERRED EMBODIMENT

Photoelectric Sterilization Water Purifier includes a metallic three-dimensional cylinder housing (17), water inlet (10), water proof cover (9) which is located at top portion of said housing (17). At bottom portion of said housing (17), there are one water outlet (7) and another water proof cover (8). The disinfected water is released from the water outlet (7).

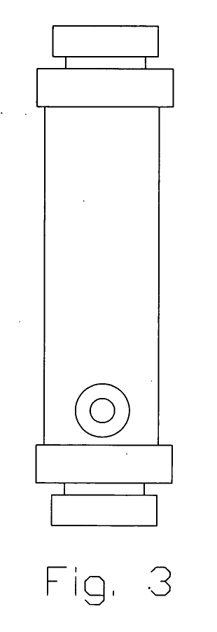

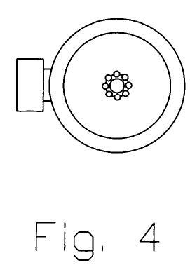

As shown in FIG. 2, said photoelectric sterilization water purifier is displayed in detail. The supporting base of an UV emission tube and said ventilation holes (6, 16) are located on upper and lower parts of said housing (17). There is a plurality of water proof cover (5) between the supporting base and the product (17) itself. Outside of said UV tube (1) is a quartz bushing (3), between said UV tube (1) and said quartz bushing (3) places a fixing emission tube (4). The spiral pipeline (2) is located inside of said housing (17).

At top portion and bottom portion of said housing (17), there are power line (12, 14, & 13), connected, and an electricity generator, rectification transformer and on/off switch thereupon.

In the process of operation, when photoelectric sterilization water purifier is activated, contaminated water comes into said water purifier through said water inlet (10), then passes through said spiral pipeline (2), circles said quartz bushing (3). said UV tube (1) emits UV to perish bacteria in the water while water proof covers (5, 8, 9) prevent water leaks from various connections. Said quartz bushing prevents fault electricity discharge from UV tube (1) which is interchargablely connected with power source, therefore assure user's safety and ensure UV's complete emission. After water passing through said UV tube (1) that perishes bacteria, the released water from outlet is disinfected therefore achieve the purpose of improving water quality.

Circuitry theory of said photoelectric sterilization water purifier in providing a mean for power input electricity goes through a wave rectification circuitry, provides power to activate UV tube (1)'s rectification circuitry. Said photoelectric sterilization water purifier employees UV emission tube to produce UV at wave length of 253.7 nanometer, which verified by the scientific research is the most effective type of UV that perishes bacteria. Said quartz bushing as a sleeve for UV tube, effectively prevents fault electrical discharge, ensure user safety and assure UV's fully emission. In this modern society, our demands on quality of life are constantly raising. The water from waterworks is up to the standard, however after it reaching taps at various locations via different channels, the water quality is below the standard when it is originated from waterworks. Photoelectric Sterilization Water Purifier provides standardized water quality, making water as fresh as if it is just come out of the waterworks.

1. A water purifier comprising:
a metallic three dimensional housing,
a plurality of quartz bushing,
a plurality of ultraviolet emission tube,
a plurality of spiral pipeline,
at least one water proof cover,
a plurality emission supporting base with ventilation holes,
a plurality of electricity input line,
at least one electricity generator,
a plurality of electricity rectification transformer and
at least one switch.

2. A water purifier as recited in claim 1, providing a mean for power input electricity goes through a wave rectification circuitry, provides power to activate UV tube (1)'s rectification circuitry. Said photoelectric sterilization water purifier employees UV emission tube to produce UV at wave length of 253.7 nanometers.

3. An electricity circuitry as recited in claim 2, the function of the rectification transformer on activation circuitry for UV emission tube that produces UV wavelength of 253.7 nm is to adjust electric current's output value.

4. A water purifier as recited in claim 1, wherein, said spiral pipeline allows incoming water circling said quartz bushing for complete exposure under UV that emitted by said UV tube to perishes bacteria in said incoming water.

5. A water purifier as recited in claim 1, wherein said quartz bushing provides a mean of prevent fault electricity discharge from UV tube and to ensure UV's complete emission.

6. A water purifier as recited in claim 1, wherein user can open the supporting base on the said air purifier to replace and/or clean said UV tube.

7. An electricity circuitry as recited in claim 2, the function of the rectification transformer on activation circuitry for UV emission tube that produces UV wavelength of 253.7 nm is to adjust electric current's output value wherein said circuitry having an ability to adapt power source of alternate current (AC).

8. A water purifier as recite in claim 1, said quartz bushing prevents fault electricity discharge from said UV tube, which is interchargablely connected with power source, therefore assure user's safety and ensure UV's complete emission.

9. A water purifier comprises:
a metallic three-dimensional cylinder housing, and
a water inlet,
a water proof cover which is located at top portion of said housing and at bottom portion of said housing, there are one water outlet and another water proof cover. The supporting base of an UV emission tube and said ventilation holes (6, 16) are located on upper and lower parts of said housing (17). There is a plurality of water proof cover (5) between the supporting base and the product (17) itself. Outside of said UV tube (1) is a quartz bushing (3), between said UV tube (1) and said quartz bushing (3) places a fixing emission tube (4). The spiral pipeline (2) is located inside of said housing (17). At top portion and bottom portion of said housing (17), there are power line (12, 14, & 13), connected, and an electricity generator, rectification transformer and on/off switch thereupon.

10. A water purifier as recite in claim 9, wherein, contaminated water comes into said water purifier through said water inlet (10), then passes through said spiral pipeline (2), circles said quartz bushing (3). said UV tube (1) emits UV to perish bacteria in the water while water proof covers (5, 8, 9) prevent water leaks from various connections. Said quartz bushing prevents fault electricity discharge from UV tube (1) which is interchargablely connected with power source, therefore assure user's safety and ensure UV's complete emission. After water passing through said UV tube (1) that perishes bacteria, the released water from outlet is disinfected therefore achieve the purpose of improving water quality.

11. A water purifier as recited in claim 9, providing a mean for power input electricity goes through a wave rectification circuitry, provides power to activate UV tube (1)'s rectification circuitry. Said photoelectric sterilization water purifier employees UV emission tube to produce UV at wave length of 253.7 nanometers.

12. An electricity circuitry as recited in claim 9, the function of said rectification transformer on activation circuitry for UV emission tube that produces UV wavelength of 253.7 nm is to adjust electric current's output value.

13. A water purifier as recited in claim 9, wherein, said spiral pipeline allows incoming water circling said quartz bushing for complete exposure under UV that emitted by said UV tube to perishes bacteria in said incoming water.

14. A water purifier as recited in claim 9, wherein said quartz bushing provides a mean of prevent fault electricity discharge from UV tube and to ensure UV's complete emission.

15. A water purifier as recited in claim 9, wherein user can open the supporting base on the said air purifier to replace and/or clean said UV tube.

16. An electricity circuitry as recited in claim 9, the function of the rectification transformer on activation circuitry for UV emission tube that produces UV wavelength of 253.7 nm is to adjust electric current's output value wherein said circuitry having an ability to adapt power source of alternate current (AC).

17. A water purifier as recite in claim 9, said quartz bushing prevents fault electricity discharge from said UV tube, which is interchargablely connected with power source, therefore assure user's safety and ensure UV's complete emission.

18.
